(19) United States
(12) Patent Application Publication
(10) Pub. No.: US 2026/0299573 A1
(43) Pub. Date: Oct. 1, 2026

(54) PRIORITY AWARE DYNAMIC CONFIGURING AUTOMATED GUIDED VEHICLES

(71) Applicant: International Business Machines Corporation, Armonk, NY (US)

(72) Inventors: Randy A. Rendahl, Raleigh, NC (US); Jennifer M. Hatfield, Portland, OR (US); Sarbajit Kumar Rakshit, Kolkata (IN); Carolina Garcia Delgado, Zapopan (MX)

(21) Appl. No.: 19/097,077

(22) Filed: Apr. 1, 2025

(51) Int. Cl. G05B 19/418; G06Q 50/04

(52) U.S. Cl. CPC G05B 19/41895; G06Q 50/04

(57) ABSTRACT

A time when a given manufacturing unit of a plurality of manufacturing units located at a corresponding manufacturing station will require a specified part is estimated based on a progress of manufacturing operations of different manufacturing units of the plurality of manufacturing units and a need for parts by each manufacturing unit of the plurality of manufacturing units. An automated guided vehicle (AGV) of a plurality of automated guided vehicles is identified for transporting the specified part and a priority is assigned to the identified automated guided vehicle based on the estimated time. Traffic on an industrial floor is dynamically controlled to enable the identified automated guided vehicle to deliver the specified part.

### BACKGROUND

The present invention relates generally to the electrical, electronic and computer arts and, more particularly, to civilian autonomous vehicles for civilian manufacturing systems, computer-assisted manufacturing, and the like.

Automated guided vehicles (AGVs) are often used in civilian applications for delivering parts to different manufacturing units, such as manufacturing robots, where the manufacturing robot(s) perform(s) a manufacturing operation. For example, different parts may be assembled to make a final product. Multiple manufacturing units located at different locations on the industrial floor can perform manufacturing activities in parallel, where each manufacturing unit receives the required parts from different AGVs that are following different routes and directions.

### BRIEF SUMMARY

Principles of the invention provide systems and techniques for priority aware dynamic configuring automated guided vehicles (AGVs). In one aspect, an exemplary method includes the operations of estimating a time when a given manufacturing unit of a plurality of manufacturing units located at a corresponding manufacturing station will require a specified part, based on a progress of manufacturing operations of different manufacturing units of the plurality of manufacturing units and a need for parts by each manufacturing unit of the plurality of manufacturing units; identifying an automated guided vehicle (AGV) of a plurality of automated guided vehicles for transporting the specified part and assigning a priority to the identified automated guided vehicle based on the estimated time; and dynamically controlling traffic on an industrial floor to enable the identified automated guided vehicle to deliver the specified part.

In one aspect, a computer program product comprises one or more tangible computer-readable storage media and program instructions stored on at least one of the one or more tangible computer-readable storage media, the program instructions executable by a processor, the program instructions comprising estimating a time when a given manufacturing unit of a plurality of manufacturing units located at a corresponding manufacturing station will require a specified part, based on a progress of manufacturing operations of different manufacturing units of the plurality of manufacturing units and a need for parts by each manufacturing unit of the plurality of manufacturing units; identifying an automated guided vehicle (AGV) of a plurality of automated guided vehicles for transporting the specified part and assigning a priority to the identified automated guided vehicle based on the estimated time; and dynamically controlling traffic on an industrial floor to enable the identified automated guided vehicle to deliver the specified part.

In one aspect, an apparatus comprises a memory and at least one processor, coupled to the memory, and operative to perform operations comprising estimating a time when a given manufacturing unit of a plurality of manufacturing units located at a corresponding manufacturing station will require a specified part, based on a progress of manufacturing operations of different manufacturing units of the plurality of manufacturing units and a need for parts by each manufacturing unit of the plurality of manufacturing units; identifying an automated guided vehicle (AGV) of a plurality of automated guided vehicles for transporting the specified part and assigning a priority to the identified automated guided vehicle based on the estimated time; and dynamically controlling traffic on an industrial floor to enable the identified automated guided vehicle to deliver the specified part.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:

the dynamic creation of a supply chain on an industrial floor using civilian AGVs for civilian manufacturing systems based on an identified demand (in manufacturing units) and supply of the relevant parts (including the manufacturing of the parts);

improving the technological process of operating a manufacturing facility by maintaining the optimal movement of AGVs on the industrial floor and providing an appropriate moving priority assignment to AGVs such that the machines (and corresponding products in production) do not have to wait for a part(s) to complete a manufacturing task;

a supply chain ecosystem that effectively manages the demand and supply of the required parts;

ensure on-time orders for a customer priority base with the optimal movement of AGVs;

AGV management that is suitable for smart manufacturing, a variety of manufacturing processes, and supply chain companies; and

an ecosystem that is continuously assessing the performance of the manufacturing site, including the timing of tasks and failures, and determining needed adjustments to maintain optimization throughout the lifecycle of the assembly.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 illustrates AGV routes on an exemplary industrial floor, in accordance with exemplary embodiments;

FIG. 2 is a representation of an exemplary industrial floor, in accordance with exemplary embodiments;

FIG. 3 illustrates the sequence of assembly of components for a personal computer, in accordance with exemplary embodiments;

FIG. 4 is a representation of an exemplary industrial floor, in accordance with exemplary embodiments;

FIG. 5 is a flowchart for an exemplary method for configuring automated guided vehicles, in accordance with exemplary embodiments;

FIG. 6 depicts a computing environment according to an embodiment of the present invention.

It is to be appreciated that elements in the figures are illustrated for simplicity and clarity.

Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Automated guided vehicles (AGVs) serve several purposes in various industries. Aspects of the invention relate to civilian AGVs for civilian manufacturing systems. Common applications of AGVs include:

manufacturing and assembly: AGVs autonomously move materials, parts, sub-assemblies and the like to stations throughout the industrial floor, warehouses and the like; and quality control and inspection: AGVs inspect machinery and products in production on the industrial floor to ensure that quality standards are met.

AGVs are often used for delivering parts to different manufacturing units, such as manufacturing robots, where the manufacturing robot(s) perform(s) a manufacturing operation. For example, different parts may be assembled to make a final product. Multiple manufacturing units located at different locations on the industrial floor can perform manufacturing activities in parallel, where each manufacturing unit receives the required parts from different AGVs that are following different routes and directions. In exemplary embodiments, techniques are provided for maintaining the optimal movement of the AGVs and providing an appropriate priority assignment to different AGVs such that the manufacturing units do not have to wait for a part(s) to complete a manufacturing task.

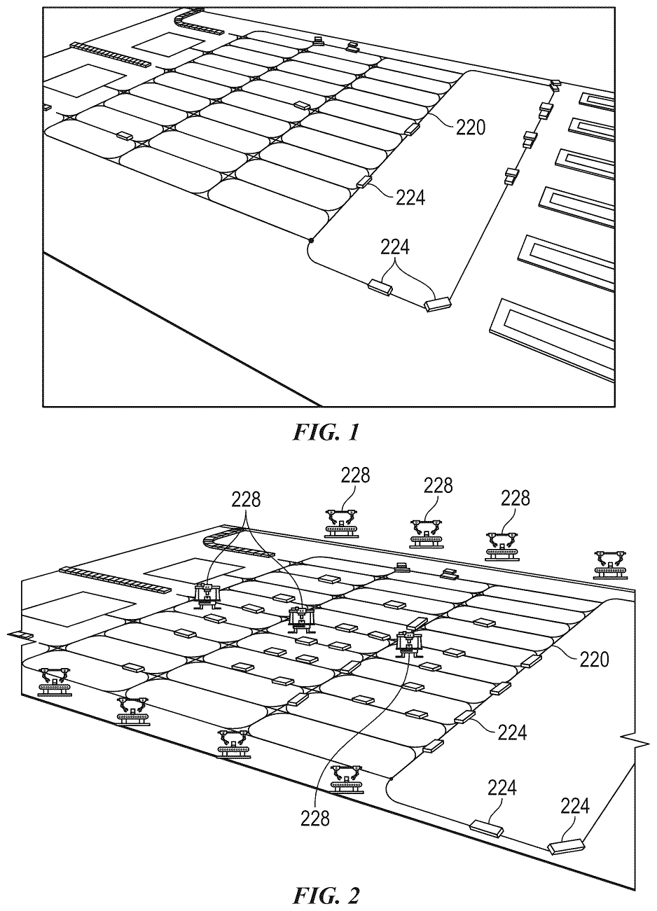

FIG. 1 illustrates AGV routes on an exemplary industrial floor, in accordance with exemplary embodiments. Tracks 220 enable AGVs 224 to follow prescribed routes throughout the industrial floor. AGVs can move in different directions; thus, at any given time, the AGVs will be moving in potentially conflicting directions. Thus, some type of priority should be assigned to the movement of each AGV.

### Smart Manufacturing

Connecting Internet of Things (IoT) devices and using cognitive capabilities to align workflows and processes are hallmarks of intelligent manufacturing plants. Generally, techniques are provided for managing a manufacturing site. In exemplary embodiments, based on the progress of manufacturing operations of different manufacturing units and the need for parts by the individual manufacturing units, the times when different manufacturing units will require the parts are estimated, such that the parts can be delivered on-time and the manufacturing units do not have to wait for a part in order to complete a manufacturing task. Accordingly, AGVs carrying different parts for different manufacturing units will be assigned the appropriate relative priority for traveling on the AGV track on the industrial floor.

In exemplary embodiments, based on the available remaining time to deliver (a) required part(s) to different manufacturing units, the allowed speed limits of the AGVs, and the like, the time required for the assigned AGV to deliver the required part to the respective target manufacturing unit is evaluated, and traffic management rules of the AGVs on the industrial floor are dynamically controlled accordingly. In exemplary embodiments, based on a comparative priority score assigned to different AGVs on the industrial floor, which AGV(s) need to stop or otherwise modify its/their movement, and which AGV(s) are allowed to move, are identified (as would occur, for example, at a crossing of AGV travel lanes on the industrial floor.

In exemplary embodiments, the relative location on the industrial floor of the AGVs having the required parts for a prioritized manufacturing activity are identified, and an appropriate score is accordingly assigned to the identified AGVs, such that the prioritized manufacturing activities obtain the required part(s) in a timely fashion.

In exemplary embodiments, the priority score of different manufacturing units, the locations of different manufacturing units (such as metal cutting and three-dimensional (3D) printing), and the like, are analyzed and, accordingly, the AGVs are configured to dynamically create a supply chain ecosystem such that the demand and supply of the required parts can be managed effectively. The priority score of a manufacturing unit can be determined based on the priority of the corresponding customer order, which can, in turn, be based on factors such as whether the articles to be manufactured are needed for a humanitarian emergency, the revenue impact of the order on the manufacturing company, the importance of the customer to the manufacturing company, and the like. (Given the teachings herein, the skilled artisan will be able to heuristically prioritize different customers based on business considerations, given the domain of interest.) More particularly, consider a company X that has a list of the most important customers, such as customers that generate the most revenue (by way of a non-limiting example, 30% of the total revenue of the company). In exemplary embodiments, the priority of the manufacturing unit is determined based on the following variables:

X=0: if the customer order is not on the list of important customers;

X=1: if the customer order is from a customer that is on the list of important customers;

Y: represents the customer orders with high revenue that are not on the list of important customers (X);

Y=1: if the customer order has a revenue greater than a user-defined threshold;

Y=0: if the customer order does not have a revenue greater than the user-defined threshold;

Z: represents whether the material to produce the order is available;

Z=0: if there is any shortage of material; and

Z=1: if all the material is ready for build.

As a first rule, the mechanism selects the orders with X=1 (as defined by the customer importance list).

As a second rule, the mechanism selects the orders with Y=1 (the high revenue orders).

As a third rule, the mechanism selects orders where the material is available (Z=1).

If one the variables X, Y, Z is assigned the number 1, the next step is performing an analysis of the priority score of the AGV based on the following steps:

analyze the assembly steps and the time required by each step. As an example, one order requires a canister assembly where the first step is installing central processing unit 1 (CPU1) (consuming 10 minutes (mins)), the second step is installing CPU2 (consuming 10 mins), the third step is installing the battery backup unit (BBU) assembly (consuming 5 mins), and steps 4-8 are installing the fan assemblies (consuming 2 mins for each fan).

Once the total time of the assembly is determined, the location of each needed part on the industrial floor is determined (including the physical location of the CPU, the battery backup units (BBUs) and the fans); the distance between these physical locations and the assembly locations is calculated; and the AGV (average speed) is determined.

In exemplary embodiments, the priority of the manufacturing unit is determined based on the following variables:

S: speed of an AGV (this variable is used in the analysis of all the AGVs where the fastest AGV is selected). The historical data is used to calculate the average speed of each AGV:

S1(AGV1 )=1.5 meters (m)/second (s); and

S2(AGV2 )=2.0 m/s.

D: distance between the location of the material and the assembly station (for example, the distance from the location of the material).

D2: distance from the BBU to the BBU assembly location is 2 meters.

DA: distance AGV is defined as the distance between the raw material location and the AGV (example AGV1 from the current distance to the location of the raw material is 1 meter).

DA1=1 meter; and

D2=4 meters.

A: assembly time where the formula is A=S+D+A; the AGV with the best result is selected as priority 1 and the AGV with the next best result is selected as priority 2.

### Conditions

(1) Once the priority of the AGV is selected for the assembly process, a route analysis is performed to validate if the desired route is available without AGVs that can interfere in the delivery step;

(2) If it is detected that one AGV that was selected as priority 5 is in the route of the AGV selected as priority 1, the AGV 5 will be instructed to stop, move aside, and the like.

In exemplary embodiments, the physical locations of the manufacturing units (such as metal cutting units, 3D printers, and the like) are identified, the AGVs are tracked, and, based on the dynamic need for the parts by the different manufacturing units, shortest route techniques (such as least square methods) are used to minimize the total distance from a node designated as the starting node or origin to another node designated as the final node and are used to reposition the manufacturing units such that, with optimal material handling by the AGVs, the manufacturing units can obtain the required parts at the appropriate time.

In exemplary embodiments, the repositioning of the manufacturing units is based on a First-In, First-Out technique and the quantity of orders produced. As an example, at the location of the manufacturing line where the raw material is located, each time that an AGV takes a component, the quantity taken is subtracted from the total amount of the raw material. For example, assume that there are 50 orders to produce for an item that uses a single BBU. Each time that an AGV takes one BBU for an order, the total amount of the BBUs is updated and, at the same time, a notification will be sent to the warehouse stock so that, when the number of BBUs in the manufacturing line is around 10 pieces that will be used in a customer order, the warehouse is informed to start moving the material from the warehouse to the manufacturing line.

In exemplary embodiments, the ecosystem is continuously assessing performance, including the timing of tasks, failures, and needed adjustments, to maintain optimization throughout the lifecycle of the manufacturing process. Different manufacturing metrics are used to assess the performance. For example, the performance can be determined by first pass yield (FPY; which helps identify how many final products were assembled without any problems and how many were assembled with a problem), good units per total units ratios (multiplied by 100 to convert to a percentage), the efficiency level of each manufacturing station (such as standard labor hours per amount of time worked), and the like.

For example, consider the FPY for two manufacturing lines assembling the same product. If, in real time, one unit is observed to have good performance in the quality level (FPY; such as around 95% performance), but the second line has a lower performance (such as 50%), the latter line will be evaluated to determine if the problem is the material, the operators and the like. Based on this analysis, it can be determined if it is better to move the customer order to another manufacturing line.

### Architecture and Systems

FIG. 2 is a representation of an exemplary industrial floor, in accordance with exemplary embodiments. As noted above, tracks 220 enable AGVs 224 to follow prescribed routes throughout the industrial floor. The AGVs 224 transport parts, materials, sub-assemblies and the like to manufacturing stations 228. Comparatively lower priority AGVs 224 will be stopped and higher priority AGVs 224 will be allowed to move; other AGVs 224 will be moving without stopping.

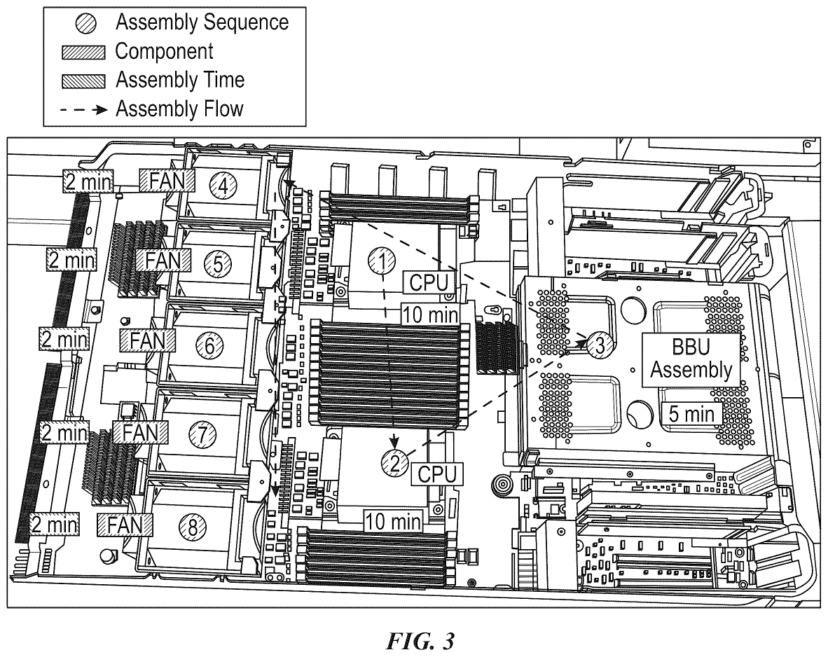

FIG. 3 illustrates the sequence of assembly of components for a personal computer, in accordance with exemplary embodiments. In exemplary embodiments, the physical location of each assembling unit, and the sequence in which the parts are utilized by different manufacturing units 228, are identified. For example, as illustrated in FIG. 3, a first central processing unit (CPU) is installed in ten minutes during a step 1, a second CPU is installed in ten minutes during a step 2, a BBU assembly is installed in five minutes during a step 3 and fans are installed in two minutes each during steps 4-8. The manufacturing workflows are analyzed, and the sequence of when and where the parts are to be manufactured is identified. Based on historical data, the time required to manufacture a part for any work product is identified.

While a work product is being manufactured, the time when the next part is to be manufactured and the timing when the part should be available at each manufacturing unit 228 to assemble a product are identified. For each part type required by the manufacturing unit 228, the projected time to needing a part is calculated using the part sequence and timing information combined with the available parts at the manufacturing station. The timing for requiring parts by different manufacturing units 228 and their relative position on the industrial floor are identified. If any priority is assigned to any manufacturing unit 228, the types of parts required on the industrial floor are identified.

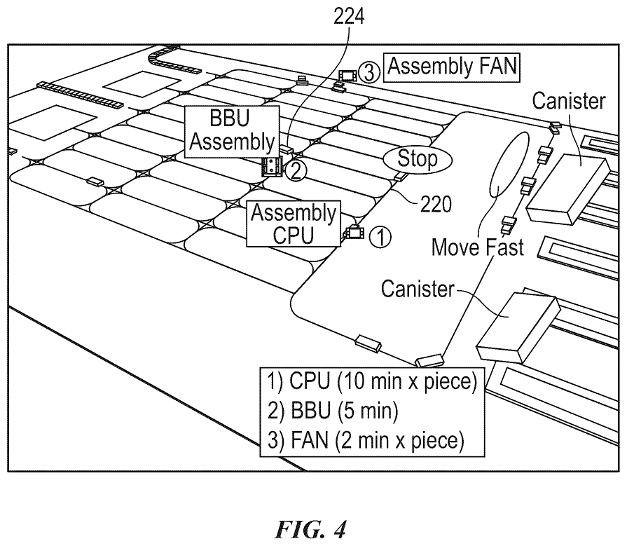

Exemplary systems identify the number of AGVs that are present on the industrial floor and their current positions on the industrial floor. FIG. 4 is a representation of an exemplary industrial floor, in accordance with exemplary embodiments. In exemplary industrial floors, there is a track 220 for each AGV 224 to follow, such as a magnetic track, and the AGVs 224 follow the track 220 while delivering parts to different manufacturing units 228. FIG. 4 shows that some AGVs 224 must be in a stopped position while another AGV 224 has to increase its speed to allow the AGVs 224 to pass in a fast manner (such as, in a non-limiting example, at 2 meters/sec).

In exemplary embodiments, input from each manufacturing unit is received, and the time(s) when different manufacturing units will be requiring parts is/are identified. At any given time, the system maintains a sorted list of part/manufacturing unit/time for a given work product.

As AGVs 224 become available, the system selects an AGV 224 from the list of available AGVs 224 using the proximity of the AGV 224 to replacement parts (either at a manufacturing unit 228 or in inventory), the time remaining until the part is needed, and the travel time to pick-up and deliver the part. Combining these, the highest entries for each manufacturing unit 228 that uses that part are evaluated, the buffer time is calculated, and the one with the least buffer time (the minimum time needed to avoid any impact in the manufacturing assembly process) after this calculation is selected. When there is a tie (or a difference within a configurable margin), manufacturing priority (for example) can be used to choose the sequence of actions. Further optimization can include allowing for the above calculation across all part types, independent of proximity, to ensure that the part(s) most at risk of being late is/are addressed first, and there is not a part type that is orphaned and debilitates the manufacturing on the entire floor.

The AGVs 224 can receive the parts directly from the manufacturing units 228, or can receive the parts from the inventory of the part (the existing inventory of the parts, such as parts coming from suppliers, parts manufactured on the industrial floor (but previously needed for assembly) and the like). The parts can be loaded on the AGVs 224 with a robotic system, either from a manufacturing machine 228 or from the inventory of the part.

In exemplary embodiments, the physical positions of different manufacturing units 224 which manufacture the parts on the industrial floor are identified and/or the location of the inventory of the part is identified.

In exemplary embodiments, the appropriate priority is assigned to AGV units 224, so that the manufacturing units 228 can obtain the required parts on time. The priority for each AGV 224 can be based on the inverse of the buffer time available to deliver the parts: the lower the buffer time, the higher the priority. In a system where some manufacturing units 228 have relative priorities, the priority is a couplet of buffer time and manufacturing priority, allowing a tie or configured margin to be decided in favor of the more highly prioritized manufacturing unit 228 (i.e., the AGV 224 delivering to that manufacturing unit 228).

In exemplary embodiments, the appropriate priority score is assigned to each AGV 224, and, accordingly, the AGVs 224 are configured with a movement plan, defining which AGV 224 is to stop, which AGV 224 will be travelling without stopping or pausing at a junction, and the like. Based on the priorities assigned to the AGVs 224, the AGVs 224 which are to stop and the AGVs 224 which will be allowed to move forward are identified. For example, AGVs 224 carrying material associated with a high priority customer may be assigned a higher priority than other AGVs 224, using appropriate heuristics or the like.

One or more exemplary embodiments determine whether the manufacturing units 228 are mobile, like 3D printers, and will be making parts during a given time period.

Based on the demand of the parts by different manufacturing units 228 and the speed of manufacturing of the parts, a shortest route or least square method is employed to identify the optimal position of the manufacturing units 228. The selected location is adjusted based on the maintained priority list to minimize the distance to the next manufacturing unit 228 that will require the subject part until it has been configured for a pickup (and again after the pickup).

Based on the identified demand (of the manufacturing units 228) and supply of, or manufacturing plan for, the parts, the AGVs 224 dynamically create a supply chain on the industrial floor.

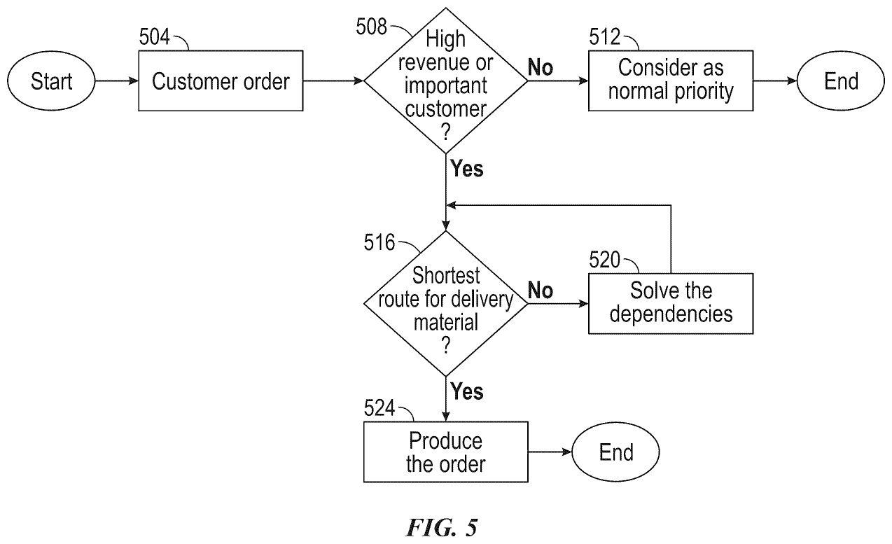

FIG. 5 is a flowchart for an exemplary method for configuring automated guided vehicles 224, in accordance with exemplary embodiments. In exemplary embodiments, a customer order is received (operation 504). A determination is made of whether the customer is an important customer or a high revenue customer (decision block 508).

If the customer is not an important customer or a high revenue customer (NO branch of decision block 508), the order is considered normal priority (operation 512).

If the customer is an important customer or a high revenue customer (YES branch of decision block 508), a determination is made of whether the shortest route for delivery of the material is available (decision block 516). If the shortest route for delivery of the material is available (YES branch of decision block 516), the order is produced (operation 524).

If the shortest route for delivery of the material is not available (NO branch of decision block 516), the dependencies are solved (operation 520) and the method proceeds with operation 516. For example, if a particular KPI is out of target (such as a target FPY for the assembly of the BBU of 95%, but with a present value of 50%), a quality alert will be triggered and an engineering team will be informed that a particular station is experiencing a problem. A “5 Whys” methodology or another quality method (such as a fishbone diagram) can be used to understand the root cause of the problem and implement the mitigation plan. For example, if a given lot of BBUs is bad, the mitigation plan should be to change the lot. If the problem is an operator/robot that is not following the assembly instructions, a training session is provided to the operator describing the proper assembly or describing how to configure the robot properly.

Given the discussion thus far, it will be appreciated that, in general terms, an exemplary method, according to an aspect of the invention, includes the operations of estimating a time when a given manufacturing unit of a plurality of manufacturing units 228 located at a corresponding manufacturing station will require a specified part, based on a progress of manufacturing operations of different manufacturing units 228 of the plurality of manufacturing units 228 and a need for parts by each manufacturing unit 228 of the plurality of manufacturing units 228; identifying an automated guided vehicle (AGV) 224 of a plurality of automated guided vehicles 224 for transporting the specified part and assigning a priority to the identified automated guided vehicle 224 based on the estimated time; and dynamically controlling traffic on an industrial floor to enable the identified automated guided vehicle 224 to deliver the specified part.

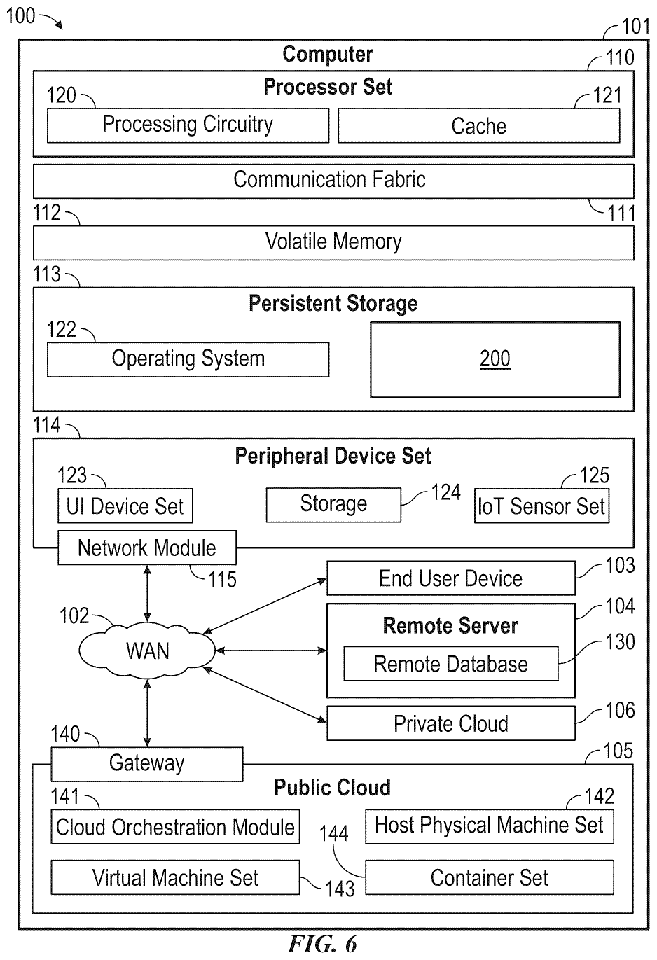

For example (see discussion of FIG. 6 elsewhere herein), code 200 communicates with vehicles, manufacturing stations, etc. as end user devices 103 over a wireless network or the like.

In exemplary embodiments, the estimating of the time is based on a part sequence and timing information combined with available parts at each manufacturing unit 228.

In exemplary embodiments, an available remaining time to deliver the specified part to a target manufacturing unit 228 of the plurality of manufacturing units 228, an allowed speed limit of the identified automated guided vehicle 224, and a time required for the identified automated guided vehicle 224 to deliver the specified part to the target manufacturing unit 2228 are evaluated, wherein the dynamically controlling the traffic on the industrial floor is based on the evaluating step.

In exemplary embodiments, a priority score and relative location of each of the plurality of manufacturing units 228 are analyzed, wherein the identifying of the automated guided vehicle (AGV) 224 is based on the priority score and the relative locations.

In exemplary embodiments, physical locations of the plurality of manufacturing units 228 are identified; the identified automated guided vehicle 224 is tracked; and a least square method is used to reposition a given manufacturing unit 228 of the plurality of manufacturing units 228 based on a dynamic need for a corresponding part by the given manufacturing unit 228.

In exemplary embodiments, a performance of the industrial floor is assessed to maintain an optimization of a lifecycle of a final product; and a given manufacturing unit 228 of the plurality of manufacturing units 228 is adjusted based on the assessed performance.

In exemplary embodiments, the assessing of the performance is based on manufacturing timing and failures.

In exemplary embodiments, a physical position on the industrial floor of different manufacturing units 228 of the plurality of manufacturing units 228 which manufacture the specified part is identified and a location of the specified part is identified.

In exemplary embodiments, a count of automated guided vehicles 224 on the industrial floor and a current position of each automated guided vehicle 224 are identified, wherein the identifying the automated guided vehicle (AGV) 224 is based on the current position of each automated guided vehicle 224.

In exemplary embodiments, an automated guided vehicle 224 of the plurality of automated guided vehicles 224 is selected based on a proximity of the selected automated guided vehicle 224 to the specified part, a time remaining until the specified part is needed, and a travel time to pick-up and deliver the specified part.

In exemplary embodiments, an automated guided vehicle priority is assigned to each remaining automated guided vehicle 224 of the plurality of automated guided vehicles 224 other than the identified automated guided vehicle 224, wherein the automated guided vehicle 224 priority is inversely proportional to a buffer time available to deliver the specified part and wherein the step of dynamically controlling the traffic further comprises controlling at least one of the remaining automated guided vehicles 224 based on the corresponding assigned priority. As used herein, the remaining automated guided vehicles 224 are the plurality of automated guided vehicles 224 excluding the identified automated guided vehicle 224.

In exemplary embodiments, the automated guided vehicle priority is a couplet of: a buffer time and a manufacturing unit priority.

In exemplary embodiments, a shortest route technique is used to identify an optimal position of each manufacturing unit 228 based on a demand of the needed parts by different manufacturing units 228 of the plurality of manufacturing units 228 and a speed of manufacturing of the needed parts.

In exemplary embodiments, an identified location for the identified automated guided vehicle 224 is adjusted based on a prioritized list of manufacturing units 228 of the plurality of manufacturing units 228 to minimize a distance to a next manufacturing unit 228 of the plurality of manufacturing units 228 that will require the specified part until the specified part has been configured for a part pickup.

In exemplary embodiments, the assigned priority is based on a priority of a corresponding customer.

In exemplary embodiments, the specified part is delivered to one of the plurality of manufacturing units 228; and the specified part is incorporated into a given product assembly.

In one aspect, a computer program product comprises one or more tangible computer-readable storage media and program instructions stored on at least one of the one or more tangible computer-readable storage media, the program instructions executable by a processor, the program instructions comprising estimating a time when a given manufacturing unit of a plurality of manufacturing units 228 located at a corresponding manufacturing station will require a specified part, based on a progress of manufacturing operations of different manufacturing units 228 of the plurality of manufacturing units 228 and a need for parts by each manufacturing unit 228 of the plurality of manufacturing units 228; identifying an automated guided vehicle (AGV) 224 of a plurality of automated guided vehicles 224 for transporting the specified part and assigning a priority to the identified automated guided vehicle 224 based on the estimated time; and dynamically controlling traffic on an industrial floor to enable the identified automated guided vehicle 224 to deliver the specified part.

In one aspect, an apparatus comprises a memory and at least one processor, coupled to the memory, and operative to perform operations comprising estimating a time when a given manufacturing unit of a plurality of manufacturing units 228 located at a corresponding manufacturing station will require a specified part, based on a progress of manufacturing operations of different manufacturing units 228 of the plurality of manufacturing units 228 and a need for parts by each manufacturing unit 228 of the plurality of manufacturing units 228; identifying an automated guided vehicle (AGV) 224 of a plurality of automated guided vehicles 224 for transporting the specified part and assigning a priority to the identified automated guided vehicle 224 based on the estimated time; and dynamically controlling traffic on an industrial floor to enable the identified automated guided vehicle 224 to deliver the specified part.

Refer now to FIG. 6.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as automated manufacturing system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 6. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
estimating a time when a given manufacturing unit of a plurality of manufacturing units located at a corresponding manufacturing station will require a specified part, based on a progress of manufacturing operations of different manufacturing units of the plurality of manufacturing units and a need for parts by each manufacturing unit of the plurality of manufacturing units;
identifying an automated guided vehicle (AGV) of a plurality of automated guided vehicles for transporting the specified part and assigning a priority to the identified automated guided vehicle based on the estimated time; and
dynamically controlling traffic on an industrial floor to enable the identified automated guided vehicle to deliver the specified part.

2. The method of claim 1, wherein the estimating of the time is based on a part sequence and timing information combined with available parts at each manufacturing unit.

3. The method of claim 1, further comprising:
evaluating an available remaining time to deliver the specified part to a target manufacturing unit of the plurality of manufacturing units, an allowed speed limit of the identified automated guided vehicle, and a time required for the identified automated guided vehicle to deliver the specified part to the target manufacturing unit;
wherein the step of dynamically controlling the traffic on the industrial floor is based on the evaluating step.

4. The method of claim 1, further comprising analyzing a priority score and relative location of each of the plurality of manufacturing units, wherein the identifying of the automated guided vehicle (AGV) is based on the priority score and the relative locations.

5. The method of claim 1, further comprising:
identifying physical locations of the plurality of manufacturing units;
tracking the identified automated guided vehicle; and
using a least square method to reposition a given manufacturing unit of the plurality of manufacturing units based on a dynamic need for a corresponding part by the given manufacturing unit.

6. The method of claim 1, further comprising:
assessing a performance of the industrial floor to maintain an optimization of a lifecycle of a final product; and
adjusting a given manufacturing unit of the plurality of manufacturing units based on the assessed performance.

7. The method of claim 6, wherein the assessing of the performance is based on manufacturing timing and failures.

8. The method of claim 1, further comprising identifying a physical position on the industrial floor of different manufacturing units of the plurality of manufacturing units which manufacture the specified part and identifying a location of the specified part.

9. The method of claim 1, further comprising identifying a count of automated guided vehicles on the industrial floor and a current position of each automated guided vehicle, wherein the identifying the automated guided vehicle (AGV) is based on the current position of each automated guided vehicle.

10. The method of claim 1, further comprising selecting an automated guided vehicle of the plurality of automated guided vehicles based on a proximity of the selected automated guided vehicle to the specified part, a time remaining until the specified part is needed, and a travel time to pick-up and deliver the specified part.

11. The method of claim 1, further comprising assigning an automated guided vehicle priority to each remaining automated guided vehicle of the plurality of automated guided vehicles other than the identified automated guided vehicle, wherein the automated guided vehicle priority is inversely proportional to a buffer time available to deliver the specified part and wherein the step of dynamically controlling the traffic further comprises controlling at least one of the remaining automated guided vehicles based on the corresponding assigned priority.

12. The method of claim 1, wherein the automated guided vehicle priority is a couplet of a buffer time and a manufacturing unit priority.

13. The method of claim 1, further comprising using a shortest route technique to identify an optimal position of each manufacturing unit based on a demand of the needed parts by different manufacturing units of the plurality of manufacturing units and a speed of manufacturing of the needed parts.

14. The method of claim 1, further comprising adjusting an identified location for the identified automated guided vehicle based on a prioritized list of manufacturing units of the plurality of manufacturing units to minimize a distance to a next manufacturing unit of the plurality of manufacturing units that will require the specified part until the specified part has been configured for a part pickup.

15. The method of claim 1, wherein the assigned priority is based on a priority of a corresponding customer.

16. The method of claim 1, further comprising:
delivering the specified part to one of the plurality of manufacturing units; and
incorporating the specified part into a given product assembly.

17. A computer program product, comprising:
one or more tangible computer-readable storage media and program instructions stored on at least one of the one or more tangible computer-readable storage media, the program instructions executable by a processor, the program instructions comprising:
estimating a time when a given manufacturing unit of a plurality of manufacturing units located at a corresponding manufacturing station will require a specified part, based on a progress of manufacturing operations of different manufacturing units of the plurality of manufacturing units and a need for parts by each manufacturing unit of the plurality of manufacturing units;
identifying an automated guided vehicle (AGV) of a plurality of automated guided vehicles for transporting the specified part and assigning a priority to the identified automated guided vehicle based on the estimated time; and
dynamically controlling traffic on an industrial floor to enable the identified automated guided vehicle to deliver the specified part.

18. A system comprising:
a memory; and
at least one processor, coupled to said memory, and operative to perform operations comprising:
estimating a time when a given manufacturing unit of a plurality of manufacturing units located at a corresponding manufacturing station will require a specified part, based on a progress of manufacturing operations of different manufacturing units of the plurality of manufacturing units and a need for parts by each manufacturing unit of the plurality of manufacturing units;
identifying an automated guided vehicle (AGV) of a plurality of automated guided vehicles for transporting the specified part and assigning a priority to the identified automated guided vehicle based on the estimated time; and
dynamically controlling traffic on an industrial floor to enable the identified automated guided vehicle to deliver the specified part.

19. The system of claim 18, wherein the operations performed by the at least one processor further comprise:
evaluating an available remaining time to deliver the specified part to a target manufacturing unit of the plurality of manufacturing units, an allowed speed limit of the identified automated guided vehicle, and a time required for the identified automated guided vehicle to deliver the specified part to the target manufacturing unit;
wherein the step of dynamically controlling the traffic on the industrial floor is based on the evaluating step.

20. The system of claim 18, wherein the operations performed by the at least one processor further comprise analyzing a priority score and relative location of each of the plurality of manufacturing units, wherein the identifying of the automated guided vehicle (AGV) is based on the priority score and the relative locations.
